(19) United States
(12) Patent Application Publication
(10) Pub. No.: US 2015/0075349 A1
(43) Pub. Date: Mar. 19, 2015

(54) Power-Tool Parting Device

(71) Applicant: Robert Bosch GmbH, Stuttgart (DE)

(72) Inventor: Milan Bozic, Solothurn (CH)

(21) Appl. No.: 14/394,299

(22) PCT Filed: Mar. 5, 2013
(86) PCT No.: PCT/EP2013/054329

§ 371 Date: Oct. 14, 2014

(30) Foreign Application Priority Data
Apr. 25, 2012 (DE) 10 2012 206 787.6

(51) Int. Cl. B27B 33/14

(52) U.S. Cl. CPC B27B 33/142
USPC 83/830

(57) ABSTRACT

A machine tool separating device has at least one cutting line. The cutting line has a changing cutting edge angle geometry along one cutting direction of the cutting line.

### PRIOR ART

There are already known power-tool parting devices that have a cutting strand.

### DISCLOSURE OF THE INVENTION

The invention is based on a power-tool parting device, having at least one cutting strand.

It is proposed that the cutting strand have a cutting-edge angle geometry that varies along a cutting direction of the cutting strand. A “cutting strand” is to be understood here to mean, in particular, a unit provided to locally undo an atomic coherence of a workpiece on which work is to be performed, in particular by means of a mechanical parting-off and/or by means of a mechanical removal of material particles of the workpiece, wherein the unit comprises cutting strand segments that are mounted so as to be movable relative to each other. Preferably, the cutting strand is provided to separate the workpiece into at least two parts that are physically separate from each other, and/or to part off and/or remove, at least partially, material particles of the workpiece, starting from a surface of the workpiece. Preferably the cutting strand is realized as a cutting chain. The cutting strand in this case may be realized as a cutting chain having one, two or three link plates. Particularly preferably, in at least one operating state, the cutting strand is moved in a revolving manner, in particular along a circumference of a guide unit of the power-tool parting device. The power-tool parting device thus preferably comprises at least one guide unit for guiding the cutting strand. The expression “guide unit” is intended here to define, in particular, a unit provided to exert a constraining force upon the cutting strand, at least along a direction perpendicular to the cutting direction of the cutting strand, in order to define a possibility for movement of the cutting strand along the cutting direction. Preferably, the guide unit has at least one guide element, in particular a guide groove, by which the cutting strand is guided. Preferably, the cutting strand, as viewed in a cutting plane, is guided by the guide unit along an entire circumference of the guide unit, by means of the guide element, in particular the guide groove.

A “cutting direction” is to be understood here to mean, in particular, a direction along which the cutting strand is moved, in at least one operating state, as a result of a driving force and/or a driving torque, in particular in the guide unit, for the purpose of producing a cutting clearance and/or parting-off and/or removing material particles of a workpiece on which work is to be performed. Preferably, the cutting strand, when in an operating state, is moved, relative to the guide unit, along the cutting direction. The cutting strand and the guide unit preferably together constitute a closed system. The term “closed system” is intended here to define, in particular, a system comprising at least two components that, by means of combined action, when the system has been demounted from a system such as, for example, a power tool, that is of a higher order than the system, maintain a functionality and/or are inseparably connected to each other when in the demounted state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents, etc.

A “cutting-edge angle geometry” is to be understood here to mean, in particular, an angle geometry of a cutting edge of a cutting element of the cutting strand, such as, for example, a magnitude of a rake angle and/or a magnitude of a clearance angle that geometrically defines the cutting edge. The cutting strand, in particular along the cutting direction, thus has a cutting-edge angle geometry that varies from one cutting strand segment to another or within a cutting strand segment of the cutting strand. Advantageously, the design of the power-tool parting device according to the invention makes it possible to achieve a high cutting rate in various types of materials of workpieces on which work is to be performed. Thus, advantageously, a wide spectrum of applications can be achieved. In this case, advantageously, the power-tool parting device according to the invention may be used for performing work on a variety of workpieces of differing materials such as, for example, wood, metal, etc.

Furthermore, it is proposed that the cutting strand comprise at least one cutting strand segment, comprising at least one cutting element, which has at least one clearance angle realized so as to differ from a clearance angle of a cutting element of a further cutting strand segment of the cutting strand. The term “clearance angle” is intended here to define, in particular, an angle that, as viewed in the cutting plane, is enclosed by a cutting edge of the cutting element of the cutting strand and by a workpiece surface of the workpiece on which work is to be performed by means of the cutting edge, while work is being performed on a workpiece, with chip removal by means of the cutting strand. Thus, advantageously, the cutting strand can be adapted to various types of material of workpieces on which work is to be performed. For example, a large clearance angle of the cutting element of the cutting strand segment may advantageously be selected for performing work on wood and/or on plastic, and a small clearance angle of the cutting element of the further cutting strand segment may advantageously be selected for performing work on metal. An operator can thus advantageously use the cutting strand for performing work on workpieces made of a hard, short-chipping material and, at the same time, for performing work on workpieces made of a soft, plastically deformable material. Advantageously, a high degree of operating comfort can be achieved, thereby providing for an advantageous saving of time.

Further, it is proposed that the cutting strand comprise at least one cutting strand segment, comprising at least one cutting element, which has at least one rake angle realized so as to differ from a rake angle of a cutting element of a further cutting strand segment of the cutting strand. A “rake angle” is to be understood here to mean, in particular, an angle enclosed by a at least substantially perpendicular to a workpiece surface of a workpiece on which work is to be performed and by a clamping face of a cutting element of the cutting strand. The clamping face is preferably constituted by a face that directly adjoins a cutting edge of the cutting element of the cutting strand. Preferably, the rake angle is disposed on a side of the cutting element of the cutting strand that faces away from the clearance angle. Advantageously, the design according to the invention enables chip spaces of the cutting strand to be configured in various ways. Advantageously, this enables the cutting strand to be used for a variety of workpieces, made of differing materials.

It is additionally proposed that the cutting strand comprise at least one cutting strand segment, comprising at least one cutting element and comprising at least one further cutting element, wherein the cutting element has a clearance angle realized so as to differ from a clearance angle of the further cutting element. The cutting element and the further cutting element in this case may be fixed to a cutter carrier element of the cutting strand segment by means of various types of connection, considered appropriate by persons skilled in the art, such as, for example, by means of a form-fitting, force-fitting and/or adhesive type of connection. Preferably, the cutting element and the further cutting element are realized so as to be integral with a cutter carrier element of the cutting strand element. “Integral with” is to be understood to mean, in particular, connected at least by adhesive force, for example by a welding process, an adhesive bonding process, an injection process and/or another process considered appropriate by persons skilled in the art, and/or, advantageously, formed in one piece such as, for example, by being produced from a casting and/or by being produced in a single or multi-component injection process and, advantageously, from a single blank. Preferably, the cutting element, the further cutting element and the cutter carrier element of the cutting strand segment are punched from a single blank. The design according to the invention makes it possible, advantageously, for the cutting strand to have a high removal rate. Owing to the integral design of the cutting element and the cutter carrier element, savings can be made, advantageously, in assembly work and costs. Particularly preferably, the further cutting element is likewise realized so as to be integral with the cutter carrier element. Thus, advantageously, a robust cutting strand segment can be achieved.

Advantageously, the cutting element of the cutting strand segment has a rake angle realized so as to differ from a rake angle of the further cutting element. Thus, advantageously, chip spaces can be configured in various ways within the cutting strand segment. It is thus advantageously possible to achieve a cutting strand segment that can be used universally for various types of material.

Furthermore, it is proposed that the cutting strand comprise at least one cutting strand segment, which has at least one cutter carrier element and at least one cutting element that together have a maximum volume that is less than 15 mm³. Preferably, all cutting strand segments of the cutting strand have a volume that is less than 15 mm³. Preferably, the cutting strand has a maximum volume that is less than 10 mm³, and particularly preferably less than 5 mm³. Advantageously inexpensive production of the cutting strand segment can be realized, requiring less material to be used.

It is additionally proposed that the cutting strand comprise at least one cutting strand segment, which has at least one cutter carrier element and at least one cutting element that together have a maximum weight that is less than 1 g. Preferably, all cutting strand segments of the cutting strand have a weight that is less than 1 g. The cutting strand segment has, in particular, a maximum weight that is less than 0.8 g, preferably less than 0.5 g, and particularly preferably less than 0.2 g. Advantageously, a light structure of the cutting strand segment can be achieved.

Further, the invention is based on a cutting strand segment of a cutting strand of a power-tool parting device according to the invention. A “cutting strand segment” is to be understood here to mean, in particular, a segment of a cutting strand provided to be connected to further segments of the cutting strand for the purpose of constituting the cutting strand. Preferably, the cutting strand segment is realized as a chain link, which is connected to further cutting strand segments, realized as chain links, for the purpose of constituting the cutting strand, preferably realized as a cutting chain. The cutting strand segment in this case may be realized as a driving member, as a connecting member, as a cutting member, etc. of a cutting chain. Preferably, the cutting strand segment comprises at least one cutter carrier element and at least one cutting element. Advantageously, an already existing cutting strand may be supplemented with a cutting strand segment according to the invention.

Furthermore, the invention is based on a power tool having at least one coupling device for coupling in a form-fitting and/or force-fitting manner to a power-tool parting device according to the invention. The power tool is preferably realized as a portable power tool. A “portable power tool” is to be understood here to mean, in particular, a power tool, in particular a hand-held power tool, that can be transported by an operator without the use of a transport machine. The portable power tool has, in particular, a mass of less than 40 kg, preferably less than 10 kg, and particularly preferably less than 5 kg. Preferably, the power tool and the power-tool parting device together constitute a power tool system. Advantageously, by means of the design of the power tool according to the invention, it is possible to achieve a power tool that, particularly advantageously, is suitable for a broad spectrum of applications.

The power-tool parting device according to the invention, the cutting strand segment according to the invention, the power tool according to the invention and/or the power tool system according to the invention are/is not intended in this case to be limited to the application and embodiment described above. In particular, power-tool parting device according to the invention, the cutting strand segment according to the invention, the power tool according to the invention and/or the power tool system according to the invention may have individual elements, components and units that differ in number from a number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a power tool according to the invention and a power-tool parting device according to the invention, which together constitute a power tool system according to the invention, in a schematic representation,

FIG. 2 shows a detail view of the power-tool parting device according to the invention, in a schematic representation,

FIG. 3 shows a detail view of a cutting strand of the power-tool parting device according to the invention, in a schematic representation,

FIG. 4 shows a detail view of a cutting-edge angle geometry of a cutting element of a cutting strand segment of the cutting strand, in a schematic representation,

FIG. 5 shows a detail view of an alternative cutting strand segment of a cutting strand of a power-tool parting device according to the invention, in a schematic representation,

FIG. 6 shows a detail view of a further, alternative cutting strand segment of a cutting strand of a power-tool parting device according to the invention, in a schematic representation, and

FIG. 7 shows a detail view of a further, alternative cutting strand segment of a cutting strand of a power-tool parting device according to the invention, in a schematic representation.

### DESCRIPTION OF THE EXEMPLARY EMBODIMENTS

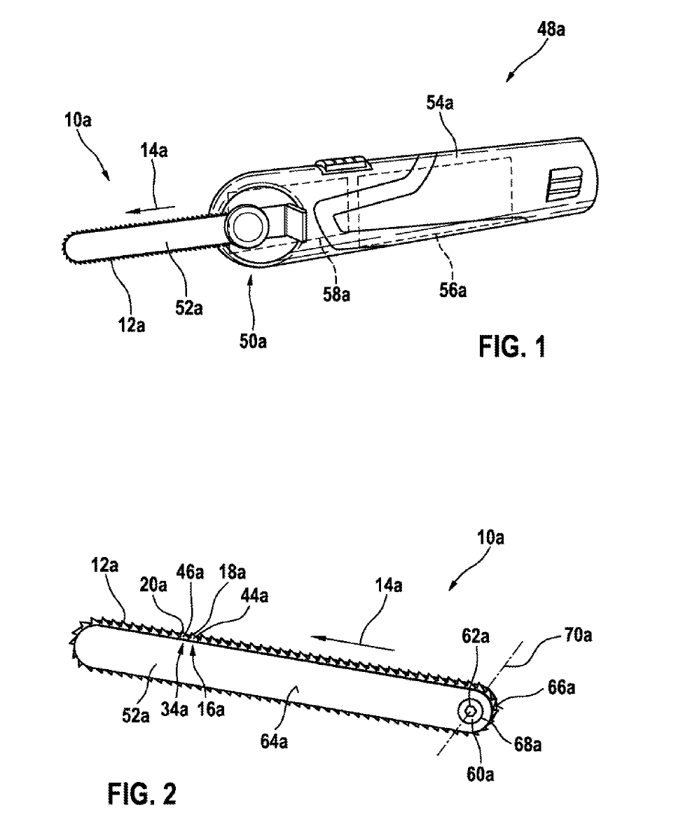

FIG. 1 shows a power tool system, which comprises a power tool 48a and a power-tool parting device 10a. The power tool 48a in this case is realized as a portable power tool. The power-tool parting device 10a comprises at least one cutting strand 12a, which has at least one cutting strand segment 16a, 34a, and at least one guide unit 52a for guiding the cutting strand 12a, wherein the guide unit 52a and the cutting strand 12a together constitute a closed system. The power tool 48a has at least one coupling device 50a, for coupling to the power-tool parting device 10a in a form-fitting and/or force-fitting manner. The coupling device 50a in this case may be realized as a bayonet closure and/or as another coupling device, considered appropriate by persons skilled in the art. The power tool 48a additionally has a power tool housing 54a, which comprises a drive unit 56a and a transmission unit 58a of the power tool 48a. The drive unit 56a and the transmission unit 58a are operatively coupled to each other to generate a driving torque that can be transmitted to the power-tool parting device 10a, in a manner already known to persons skilled in the art. The transmission unit 58a is realized as a bevel gear transmission. The drive unit 56a is realized as an electric motor unit. It is also conceivable, however, for the drive unit 56a and/or the transmission unit 58a to be of a different design, considered appropriate by persons skilled in the art. The drive unit 56a is provided to drive the cutting strand 12a of the power-tool parting device 10a in at least one operating state, via the transmission unit 58a. In this case, the cutting strand 12a, in the guide unit 52a of the power-tool parting device 10a, is moved along a cutting direction 14a of the cutting strand 12a, in the guide unit 52a.

FIG. 2 shows the power-tool parting device 10a decoupled from the coupling device 50a of the power tool 48a. The power-tool parting device 10a has the cutting strand 12a and the guide unit 52a, which together constitute a closed system. The cutting strand 12a is guided by means of the guide unit 52a. For this purpose, the guide unit 52a has at least one guide element (not represented in greater detail here), realized as a guide groove, by means of which the cutting strand 12a is guided. The cutting strand 12a in this case is guided by means of edge regions of the guide unit 52a that delimit the guide groove. It is also conceivable, however, for the guide element to be realized in a different manner, considered appropriate by persons skilled in the art, such as, for example, as a rib-type formation on the guide unit 52a, which engages in a recess on the cutting strand 12a. The cutting strand 12a comprises, in particular, a multiplicity of cutting strand segments that are connected to each other.

For the purpose of driving the cutting strand 12a, the power-tool parting device 10a or the power tool 48a has a torque transmission element 60a, which can be connected to the drive unit 56a and/or to the transmission unit 58a for the purpose of transmitting forces and/or torques to the cutting strand 12a. In the case of the power tool 48a being designed to have the torque transmission element (not represented in greater detail here), the torque transmission element is connected to the cutting strand 12a while the power-tool parting device 10a and the coupling device 50a are coupled. In the case of the power-tool parting device 10a being designed to have the torque transmission element 60a, the torque transmission element 60a and the cutting strand 12a are in engagement even after decoupling from the coupling device 50a. For the purpose of coupling the torque transmission element 60a, realized with the power-tool parting device 10a, and the drive unit 56a and/or the transmission unit 58a, the torque transmission element 60a has a coupling recess 62a, in which a pinion (not represented in greater detail here) of the drive unit 56a and/or a toothed wheel (not represented in greater detail here) and/or a toothed shaft (not represented in greater detail here) of the transmission unit 58a engages, when in an assembled state. The coupling recess 62a is disposed concentrically in the torque transmission element 60a. Moreover, the torque transmission element 60a is realized as a toothed wheel. The torque transmission element 60a is mounted, at least partially, in the guide unit 52a. The torque transmission element 60a in this case, as viewed along a direction perpendicular to the cutting plane, is disposed, at least partially, between outer faces 64a, 66a of the guide unit 52a, in a recess 68a of the guide unit 52a. Moreover, the torque transmission element 60a is mounted in the guide unit 52a so as to be rotatable about a rotation axis 70a.

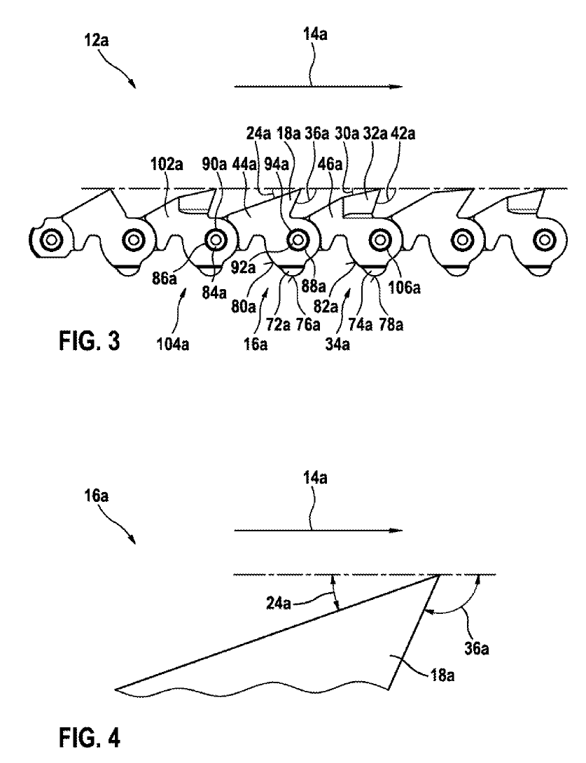

FIG. 3 shows a detail view of the cutting strand 12a of the power-tool parting device 10a. The cutting strand 12a has a cutting-edge angle geometry that varies along the cutting direction 14a of the cutting strand 12a. The cutting strand 12a in this case comprises at least one cutting strand segment 16a, comprising at least one cutting element 18a, which has at least one clearance angle 24a (FIG. 4) realized so as to differ from a clearance angle 30a of a cutting element 32a of a further cutting strand segment 34a of the cutting strand 12a. The clearance angle 24a of the cutting element 18a of the cutting strand segment 16a is less than 50°. In this case, the clearance angle 24a of the cutting element 18a of the cutting strand segment 16a has an angular dimension of between 15° and 50°. The clearance angle 30a of the cutting element 32a of the further cutting strand segment 34a is less than 80°. The clearance angle 30a of the cutting element 32a of the further cutting strand segment 34a has an angular dimension of between 20° and 80°, wherein the clearance angle 30a of the cutting element 32a of the further cutting strand segment 34a always differs from the clearance angle 24a of the cutting element 18a of the cutting strand segment 16a. Moreover, the cutting element 18a of the cutting strand segment 16a has at least one rake angle 36a (FIG. 4) realized so as to differ from a rake angle 42a of the cutting element 32a of the further cutting strand segment 34a. The cutting strand segment 16a additionally comprises a cutter carrier element 44a, which is realized so as to be integral with the cutting element 18a of the cutting strand segment 16a. The further cutting strand segment 34a likewise comprises a cutter carrier element 46a, which is realized so as to be integral with the cutting element 32a of the further cutting strand segment 34a.

The cutting strand segment 16a and the further cutting strand segment 34a each comprise at least one cutter carrier element 44a, 46a, and at least one cutting element 18a, 32a each. In this case, the cutting strand segment 16a and the further cutting strand segment 34a each have a maximum volume that is less than 15 mm³. In particular, the maximum volume of the cutting strand segment 16a and of the further cutting strand segment 34a is less than 5 mm³ in each case. Moreover, the cutting strand segment 16a and the further cutting strand segment 34a each have a maximum weight that is less than 1 g. In this case, a maximum weight of the cutting strand segment 16a and of the further cutting strand segment 34a is less than 0.2 g in each case.

Moreover, the cutter carrier element 44a of the cutting strand segment 16a has at least one segment guide element 72a, which is provided to limit a movement of the cutter carrier element 44a of the cutting strand segment 16a, when disposed in the guide unit 52a, as viewed in a direction away from the guide unit 52a, at least along the direction that is at least substantially parallel to the cutting plane. The segment guide element 72a is constituted by a transverse projection that extends at least substantially perpendicularly in relation to the cutting plane. The segment guide element 72a in this case delimits a longitudinal groove. The segment guide element 72a is provided to act in combination with segment guide elements (not represented in greater detail here) that are realized as a rib or perforation and disposed on the inner wall of the guide unit 52a that faces toward the cutter carrier element 44a of the cutting strand segment 16a, for the purpose of limiting movement. The segment guide elements are realized so as to correspond with the segment guide element 72a. The cutter carrier element 46a of the further cutting strand segment 34a likewise comprises a segment guide element 74a, which is similar in design to the segment guide element 72a.

Moreover, the cutter carrier element 44a of the cutting strand segment 16a has a compressive-force transfer face 76a. The compressive-force transfer face 76a is provided, by acting in combination with a compressive-force absorption region (not represented in greater detail here) of the guide unit 52a, to support compressive forces that act upon the cutting strand 12a as work is being performed on a workpiece (not represented in greater detail here). In this case, the compressive-force absorption region of the guide unit 52a, as viewed along a direction that is at least substantially perpendicular to the cutting plane of the cutting strand 12a, is disposed between the outer faces 64a, 66a of the guide unit 52a that are at least substantially parallel to each other. The cutter carrier element 46a of the further cutting strand segment 34a likewise comprises a compressive-force transfer face 78a, which is similar in design to the compressive-force transfer face 76a.

The cutter carrier element 44a of the cutting strand segment 16a additionally has a driving face 80a, which is provided to act in combination with driving faces of a torque transmission element 60a, for the purpose of driving the cutting strand 12a. The driving faces of the torque transmission element 60a in this case are realized as tooth flanks. In this case, the driving face 80a of the cutter carrier element 44a of the cutting strand segment 16a is realized so as to correspond with the driving faces of the torque transmission element 60a. When the cutting strand 12a is being driven, the tooth flanks of the torque transmission element 60a bear temporarily against the driving face 80a of the cutter carrier element 44a of the cutting strand segment 16a, for the purpose of transmitting driving forces. The cutter carrier element 46a of the further cutting strand segment 34a likewise comprises a driving face 82a, which is similar in design to the driving face 80a.

The cutting strand 12a additionally has at least one connecting element 84a, which is realized so as to be integral with the cutter carrier element 44a of the cutting strand segment 16a. The connecting element 84a is realized in the form of a stud and extends at least substantially perpendicularly in relation to the cutting plane. The connecting element 84a in this case is provided, by acting in combination with a connecting recess 86a of a cutter carrier element 102a of an additional cutting strand segment 104a of the cutting strand 12a, to realize a form-fitting connection between the cutter carrier element 44a of the cutting strand segment 16a and the additional cutter carrier element 102a of the additional cutting strand segment 104a. The cutter carrier element 44a of the cutting strand segment 16a and the cutter carrier element 46a of the further cutting strand segment 34a each likewise comprise a connecting recess 88a, 106a, in which a further connecting element (not represented in greater detail here) of the cutting strand 12a can be disposed, in order to form the cutting strand 12a. The cutter carrier element 46a of the further cutting strand segment 34a likewise comprises a connecting element 92a, which is similar in design to the connecting element 84a. Each cutter carrier element of the cutting strand 12a thus comprises at least one connecting element and at least one connecting recess. By means of a combined action of the connecting elements and the connecting recesses, the cutter carrier elements of the cutting strand 12a are mounted so as to be pivotable relative to each other. The cutting strand segment 16a and the further cutting strand segment 34a are thus similar to each other in their design.

In addition, the cutter carrier element 44a of the cutting strand segment 16a has at least one transverse securing element 90a, which is provided to secure insofar as possible the cutter carrier element 44a of the cutting strand segment 16a, when in a mounted state, against a transverse movement relative to the further cutter carrier element 46a of the further cutting strand segment 34a of the cutting strand 12a. The transverse securing element 90a of the cutter carrier element 44a of the cutting strand segment 16a is disposed on the connecting element 84a of the cutter carrier element 44a of the cutting strand segment 16a. It is also conceivable, however, for the transverse securing element 90a of the cutter carrier element 44a of the cutting strand segment 16a to be disposed at a different region of the cutter carrier element 44a of the cutting strand segment 16a, considered appropriate by persons skilled in the art, such as, for example, in a coupling region, in which the connecting element 84a of the cutter carrier element 44a of the cutting strand segment 16a is disposed and which, when the cutter carrier element 44a of the cutting strand segment 16a is coupled to the further cutter carrier element 46a of the further cutting strand segment 34a, contacts a lateral face of the further cutter carrier element 46a, at least partially. The cutter carrier element 46a of the further cutting strand segment 34a likewise comprises a transverse securing element 94a, which is similar in design to the transverse securing element 90a.

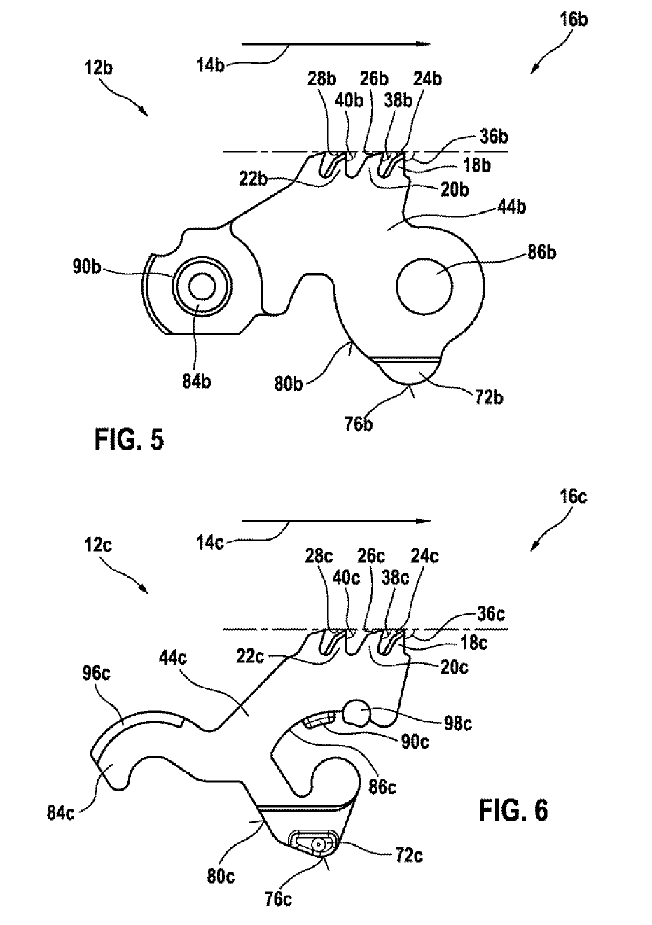

Alternative exemplary embodiments are represented in FIGS. 5 to 7. Components, features and functions that remain substantially the same are denoted basically by the same references. To differentiate the exemplary embodiments, the letters a to d have been appended to the references of the exemplary embodiments. The following description is limited substantially to the differences as compared with the first exemplary embodiment described in FIGS. 1 to 4, and reference may be made to the description of the first exemplary embodiment in FIGS. 1 to 4 in respect of components features and functions that remain the same.

FIG. 5 shows a detail view of an alternative cutting strand segment 16b of a cutting strand 12b of a power-tool parting device (not represented in greater detail here). The cutting strand 12b has a cutting-edge angle geometry that varies along a cutting direction 14b of the cutting strand 12b. The cutting strand segment 16b comprises at least one cutting element 18b and at least one further cutting element 20b, wherein the cutting element 18b has a clearance angle 24b realized so as to differ from a clearance angle 26b of the further cutting element 20b. In addition, the cutting strand segment 16b has at least one additional cutting element 22b, which has a clearance angle 28b that differs from the clearance angle 24b of the cutting element 18b and/or from the clearance angle 26b of the further cutting element 20b. It is also conceivable, however, for the cutting strand segment 16b to have a number of cutting elements other than three. Moreover, the cutting element 18b has a rake angle 36b realized so as to differ from a rake angle 38b of the further cutting element 20b. Further, the additional cutting element 22b has a rake angle 40b that differs from the rake angle 36b of the cutting element 18b and/or from the rake angle 40b of the further cutting element 20b. Further, the cutting strand segment 16b comprises at least one cutter carrier element 44b, which is realized so as to be integral with the cutting element 18b, the further cutting element 20b and the additional cutting element 22b. In respect of further features of the cutting strand segment 16b, reference may be made to the exemplary embodiment described in FIGS. 1 to 4.

FIG. 6 shows a detail view of a further alternative cutting strand segment 16c of a cutting strand 12c of a power-tool parting device (not represented in greater detail here). The cutting strand 12c has a cutting-edge angle geometry that varies along a cutting direction 14c of the cutting strand 12c. The cutting strand segment 16c comprises at least one cutting element 18c and at least one further cutting element 20c, wherein the cutting element 18c has a clearance angle 24c realized so as to differ from a clearance angle 26c of the further cutting element 20c. In addition, the cutting strand segment 16c has at least one additional cutting element 22c, which has a clearance angle 28c that differs from the clearance angle 24c of the cutting element 18c and/or from the clearance angle 26c of the further cutting element 20c. It is also conceivable, however, for the cutting strand segment 16c to have a number of cutting elements other than three. Moreover, the cutting element 18c has a rake angle 36c realized so as to differ from a rake angle 38c of the further cutting element 20c. Further, the additional cutting element 22c has a rake angle 40c that differs from the rake angle 36c of the cutting element 18c and/or from the rake angle 40c of the further cutting element 20c.

Further, the cutting strand segment 16c comprises at least one cutter carrier element 44c, which is realized so as to be integral with the cutting element 18c, the further cutting element 20c and the additional cutting element 22c. For the purpose of forming the cutting strand 12c, the cutter carrier element 44c comprises at least one connecting element 84c. The connecting element 84c is realized so as to be integral with the cutter carrier element 44c. The connecting element 84c in this case is realized as a longitudinal extension of the cutter carrier element 44c. The longitudinal extension is realized in the shape of a hook. The longitudinal extension in this case is other than a bar-shaped extension, on which there is formed a circular form-fitting element, and/or other than a semicircular extension. Furthermore, the connecting element 84c realized as a longitudinal extension has a transverse securing region 96b on one side. The transverse securing region 96c is provided, by acting in combination with at least one transverse securing element of a further cutter carrier element (not represented in greater detail here) of a further cutting strand segment of the cutting strand 12c, which further cutter carrier element is connected to the cutter carrier element 44c, to prevent, at least insofar as possible, a transverse movement of the cutter carrier element 44c along at least two opposing directions, when in a coupled state, relative to the further cutter carrier element. In this case, the transverse securing region 96c is realized as a rib. It is also conceivable, however, for the transverse securing region 96c to be of a different design, considered appropriate by persons skilled in the art, such as, for example, designed as a groove, etc. The transverse securing region 96c is disposed on a side of the connecting element 84c that faces toward the cutting elements 18c, 20c, 22c that are realized so as to be integral with the cutter carrier element 44c.

The cutter carrier element 44c additionally has two transverse securing elements 90c, 98c, which are provided, when the cutter carrier element 44c has been coupled to the further cutter carrier element, to act in combination with a transverse securing region of the further cutter carrier element. The transverse securing elements 90c, 98c are each disposed in an edge region of the cutter carrier element 44c that delimits a connecting recess 86c of the cutter carrier element 44c. The transverse securing elements 90c, 98c in this case are realized so as to be integral with the cutter carrier element 44c. The transverse securing elements 90c, 98c are each integrally formed on to the cutter carrier element 44c by means of a stamping process.

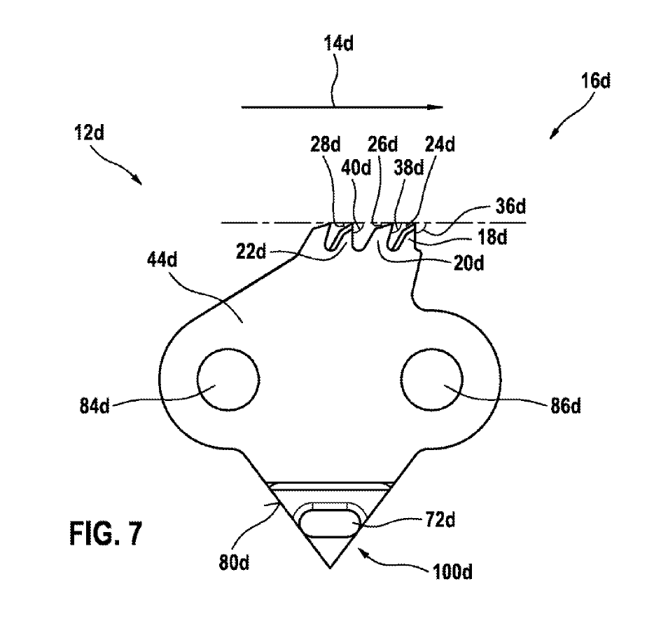

FIG. 7 shows a further alternative cutting strand segment 16d of a cutting strand 12d of a power-tool parting device (not represented in greater detail here). The cutting strand 12d has a cutting-edge angle geometry that varies along a cutting direction 14d of the cutting strand 12d. The cutting strand segment 16d comprises at least one cutting element 18d and at least one further cutting element 20d, wherein the cutting element 18d has a clearance angle 24d realized so as to differ from a clearance angle 26d of the further cutting element 20d. In addition, the cutting strand segment 16d has at least one additional cutting element 22d, which has a clearance angle 28d that differs from the clearance angle 24d of the cutting element 18d and/or from the clearance angle 26d of the further cutting element 20d. It is also conceivable, however, for the cutting strand segment 16d to have a number of cutting elements other than three. Moreover, the cutting element 18d has a rake angle 36d realized so as to differ from a rake angle 38d of the further cutting element 20d. Further, the additional cutting element 22d has a rake angle 40d that differs from the rake angle 36d of the cutting element 18d and/or from the rake angle 40d of the further cutting element 20d.

Further, the cutting strand segment 16d comprises at least one cutter carrier element 44d, which is realized so as to be integral with the cutting element 18d, the further cutting element 20d and the additional cutting element 22d. For the purpose of forming the cutting strand 12d, the cutter carrier element 44d comprises a connecting element 84d, in the form of a stud, and a connecting recess 88d, into which a stud-type connecting element (not represented in greater detail here) of a further cutter carrier element (not represented in greater detail here) of a further cutting strand segment of the cutting strand 12d can be brought. It is also conceivable, however, for the cutter carrier element 44d to be realized so as to be separate from the connecting element 84d, and to have instead two connecting recesses 88d, into each of which a stud-type connecting element can be inserted, for the purpose of forming the cutting strand 12d. Moreover, the cutter carrier element 44d comprises at least one segment guide element 72d. The cutter carrier element 44d additionally comprises a driving region 100d, which has a triangular shape. In this case, the segment guide element 72d is disposed in the driving region 100d. Further, a driving face 80d of the cutter carrier element 44d is disposed in the driving region 100d.

1. A power-tool parting device, comprising:
at least one cutting strand,
wherein the at least one cutting strand has a cutting-edge angle geometry that varies along a cutting direction of the at least one cutting strand.

2. The power-tool parting device as claimed in claim 1, wherein:
the cutting strand includes at least one cutting strand segment, the at least one cutting strand segment including at least one cutting element, and
the at least one cutting element has at least one clearance angle configured so as to differ from a clearance angle of a cutting element of a further cutting strand segment of the at least one cutting strand.

3. The power-tool parting device as claimed in claim 1, wherein:
the at least one cutting strand includes at least one cutting strand segment, the at least one cutting strand segment including at least one cutting element, and
the at least one cutting element has at least one rake angle configured so as to differ from a rake angle of a cutting element of a further cutting strand segment of the at least one cutting strand.

4. The power-tool parting device as claimed in claim 1, wherein:
the at least one cutting strand comprises at least one cutting strand segment, the at least one cutting strand segment including at least one cutting element and at least one further cutting element, and
the at least one cutting element has a clearance angle configured so as to differ from a clearance angle of the at least one further cutting element.

5. The power-tool parting device as claimed in claim 4, wherein the at least one cutting element has a rake angle configured so as to differ from a rake angle of the at least one further cutting element.

6. The power-tool parting device as claimed in claim 1, wherein the at least one cutting strand includes at least one cutting strand segment, the at least one cutting strand segment having at least one cutter carrier element and at least one cutting element that together have a maximum volume that is less than 15 mm³.

7. The power-tool parting device as claimed in claim 1, wherein the at least one cutting strand includes at least one cutting strand segment, which has at least one cutter carrier element and at least one cutting element that together have a maximum weight that is less than 1 g.

8. A cutting strand segment of a cutting strand of a power-tool parting device, the cutting strand segment comprising:
at least one cutting element having at least one clearance angle configured so as to differ from a clearance angle of a cutting element of a further cutting strand segment of the cutting strand,
wherein the cutting strand has a cutting-edge angle geometry that varies along a cutting direction of the cutting strand.

9. A power tool, comprising:
at least one coupling device configured to couple in a form-fitting and/or force-fitting manner to a power-tool parting device,
wherein the power-tool parting device has at least one cutting strand, the at least one cutting strand having a cutting-edge angle geometry that varies along a cutting direction of the cutting strand,
wherein the at least one cutting strand includes at least one cutting strand segment having at least one cutting element, and
wherein the at least one cutting element has at least one clearance angle configured so as to differ from a clearance angle of a further cutting strand segment of the at least one cutting strand.

10. The power tool as claimed in claim 9, wherein the power tool is included in a power tool system.
